(19) United States
(12) Patent Application Publication
(10) Pub. No.: US 2013/0050165 A1
(43) Pub. Date: Feb. 28, 2013

(54) DEVICE AND METHOD FOR LIGHT SOURCE CORRECTION FOR REFLECTIVE DISPLAYS

(71) Applicants: Craig William Northway, Aspley (AU); Craig Matthew Brown, Freshwater (AU); Jessica May Purser, Ashfield (AU)

(72) Inventors: Craig William Northway, Aspley (AU); Craig Matthew Brown, Freshwater (AU); Jessica May Purser, Ashfield (AU)

(73) Assignee: QUALCOMM MEMS Technologies, Inc., San Diego, CA (US)

(21) Appl. No.: 13/217,140

(22) Filed: Aug. 24, 2011

(51) Int. Cl. G09G 5/00

(52) U.S. Cl. 345/207

(57) ABSTRACT

This disclosure provides systems, methods and apparatus, including computer programs encoded on computer storage media for color correction in display devices. In one aspect, the display device can include a plurality of display elements capable of reflecting ambient light. The display device can include a sensor to determine a color temperature of the ambient light. The display device also can include a processor that can receive image data, determine a color conversion parameter based on the color temperature, perform color conversion of the image data based on the color conversion parameter, and adjust at least one display element based on the color converted image data to provide a color within the color gamut of the ambient light.

### TECHNICAL FIELD

This disclosure relates to electromechanical systems, and more particularly to color correction or adjustment in displays having such systems.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

One innovative aspect of the subject matter described in this disclosure can be implemented in a display device. The display device can include a plurality of display elements. Each display element can be capable of reflecting ambient light. The display device also can include a sensor configured to determine a color temperature of the ambient light. The display device further can include a processor. The processor can be configured to receive image data to be displayed as an image by the plurality of display elements, can be configured to determine at least one color conversion parameter based at least in part on the color temperature, and can be configured to perform color conversion of the image data based at least in part on the at least one color conversion parameter. The color conversion parameter can include, e.g., a white point of the ambient light. In various implementations, the color conversion can be adapted to provide colors within a color gamut of the ambient light. The processor also can be configured to adjust at least one of the plurality of display elements based at least in part on the color converted image data to provide a color within the color gamut of the ambient light. In some implementations, the color conversion may include adjusting color values that might be outside the color gamut of the ambient light to remain in the color gamut of the ambient light. In various implementations, the sensor can be configured to determine the color temperature of the ambient light when the processor receives the image data.

In some implementations, the processor can be configured to perform the color conversion of the image data based at least in part on one or more look-up tables or on one or more algorithms. In some implementations, the processor can be configured to determine a standard color temperature that approximately matches the determined color temperature and to perform the color conversion of the image data based at least in part on the standard color temperature. The plurality of display elements can include an interferometric modulator having an interferometric cavity. The plurality of display elements can be adjusted by adjusting an interferometric cavity spacing of at least one interferometric modulator, by adjusting an amount of time when the ambient light is reflected by at least one interferometric modulator, or by adjusting a reflective area used to reflect the ambient light by at least one interferometric modulator.

In some implementations, the display device can include a memory device that is configured to communicate with the processor. The display device can also include a driver circuit configured to send at least one signal to at least one of the plurality of display elements. The processor can be configured to send at least a portion of the color converted image data to the driver circuit. The display device further can include an image source module configured to send the image data to the processor. The image source module can include at least one of a receiver, transceiver, and transmitter. The display device also can include an input device configured to receive input data and to communicate the input data to the processor.

Another innovative aspect of the subject matter described in this disclosure can be implemented in a display device. The display device can include a plurality of display elements capable of reflecting ambient light. The display device can include means for determining a color temperature of the ambient light and means for adjusting at least one of the plurality of display elements based at least in part on the color temperature determined to provide colors within a color gamut of the ambient light. The display device further can include means for receiving image data to be displayed as an image by the plurality of display elements, means for determining at least one color conversion parameter based at least in part on the color temperature, and means for performing color conversion of the image data based at least in part on the at least one color conversion parameter. The color conversion can be adapted to provide colors within a color gamut of the ambient light. In some implementations, the color conversion may include adjusting color values that might be outside the color gamut of the ambient light to remain in the color gamut of the ambient light.

In some implementations, the means for determining a color temperature of the ambient light can include a sensor. The means for determining a color temperature of the ambient light can be configured to determine the color temperature of the ambient light when the image data is received. Various implementations of the means for adjusting at least one of the plurality of display elements can include a processor. The means for determining at least one color conversion parameter can include a color conversion parameter selection module and the means for performing color conversion of the image data can include a color conversion module. The at least one color conversion parameter can be the white point of the ambient light. The means for performing color conversion of the image data can be configured to perform the color conversion of the image data based at least in part on one or more look-up tables or on one or more algorithms. In some implementations, the means for determining at least one color conversion parameter can be configured to determine a standard color temperature that approximately matches the determined color temperature. The means for performing color conversion of the image data can be configured to perform the color conversion of the image data based at least in part on the standard color temperature. In some implementations, the display elements can include an interferometric modulator. In these implementations, the at least one of the plurality of display elements can be adjusted by adjusting an interferometric cavity spacing of at least one interferometric modulator, by adjusting an amount of time when the ambient light is reflected by at least one interferometric modulator, or by adjusting a reflective area used to reflect the ambient light by at least one interferometric modulator.

Another innovative aspect of the subject matter described in this disclosure can be implemented in a method for color correction in a display device. The method can include receiving image data to be displayed as an image by the display device. The display device can include a plurality of display elements capable of reflecting ambient light, receiving a color temperature of the ambient light, determining at least one color conversion parameter based at least in part on the received color temperature, and performing color conversion of the image data based at least in part on the at least one color conversion parameter. The color conversion can be adapted to provide colors within a color gamut of the ambient light. The method also can include adjusting at least one of the plurality of display elements based at least in part on the color converted image data. In some implementations, the color conversion may include adjusting color values that might be outside the color gamut of the ambient light to remain in the color gamut of the ambient light. In some implementations, the method can include performing color conversion of the image data based at least in part on one or more look-up tables or algorithms. In some implementations, the display elements can include an interferometric modulator. In these implementations, adjusting at least one of the plurality of display elements can include one or more of adjusting an interferometric cavity spacing of at least one interferometric modulator, adjusting an amount of time when the ambient light is reflected by at least one interferometric modulator, and adjusting an area used to reflect the ambient light by at least one interferometric modulator.

Another innovative aspect of the subject matter described in this disclosure can be implemented in a non-transitory tangible computer storage medium having stored thereon instructions that, when executed by a computing system, can cause the computing system to perform operations. The operations can include receiving image data to be displayed as an image by a plurality of display elements capable of reflecting ambient light. The operations also can include receiving a color temperature of the ambient light, determining at least one color conversion parameter based at least in part on the received color temperature, and performing color conversion of the image data based at least in part on the at least one color conversion parameter. The color conversion can be adapted to provide colors within a color gamut of the ambient light. In some implementations, the color conversion may include adjusting color values that might be outside the color gamut of the ambient light to remain in the color gamut of the ambient light. The operations further can include adjusting at least one of the plurality of display elements based at least in part on the color converted image data. In the non-transitory tangible computer storage medium, performing color conversion of the image data can be based in part on one or more look-up tables or algorithms. In some implementations, the operations further can include determining a standard color temperature that approximately matches the received color temperature. Performing the color conversion of the image data can be based at least in part on the standard color temperature.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 is an example chromaticity diagram that illustrates the colors that can be produced by a display device that includes display elements that produce red, green, and blue colors.

FIGS. 10A and 10B illustrate examples of display devices for displaying an image.

FIG. 11A illustrates an example algorithm to correct or adjust for color temperature of ambient light in a display device.

FIG. 11B illustrates an example method to correct or adjust for color temperature of ambient light in a display device.

FIGS. 12A and 12B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., electromechanical systems (EMS), MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

Because reflective displays can use ambient light, e.g., incandescent light, fluorescent light, and/or sunlight, as a light source, the color temperature of the light source can affect the color temperature of light reflected from the reflective display. The color temperature of a light source (or of light reflected from a reflective display) can be referred to as a comparison to the light emitted by a black body radiator at a particular temperature. For example, a black body spectrum at 5,500 K may be referred to as having a color temperature of 5,500 K. Lower color temperatures, e.g., less than 5,500 K, can be considered warm and appear more yellow. The white point of a light source (or of light reflected from a reflective display) can be considered as the hue that is neutral (e.g., gray or achromatic). Thus, a display used under an incandescent light source having a color temperature of 5,500 K may be perceived as yellowish white. Accordingly, some implementations provide a display device that can be configured to dynamically adjust the output light to correct or adjust for the color temperature of the ambient light incident on the display. In some such implementations, the display device includes a reflective display.

A display device can include a plurality of display elements. Each display element can include an interferometric modulator. Each interferometric modulator can have an interferometric cavity and can be configured to reflect ambient light within the interferometric cavity. The display device also can include a sensor and a processor. In some implementations, as the processor receives image data to be displayed as an image by the plurality of display elements, the sensor can determine, e.g., by measuring, calculating, or estimating, a color temperature of the ambient light and perform color conversion of the image data, if desired, based at least in part on a color conversion parameter. The processor also can adjust the plurality of display elements based on the color converted image data to provide a color within the color gamut of the ambient light.

Particular implementations of the subject matter described in this disclosure can be used to realize one or more of the following potential advantages. Various implementations of a display device described herein can correct or adjust for the color temperature of the ambient light without the use of an auxiliary light source, e.g., to provide an acceptable or desirable color within the color gamut of the ambient light. In some implementations, a display can produce colors that appear substantially unaffected or significantly less affected by the color temperature of the ambient light source. For example, by varying the colors displayed on the display, the apparent, e.g., “bluish” tinge of a high color temperature light source (such as fluorescent light) or, e.g., “yellowish” tinge of a low color temperature light source (such as incandescent light) can be reduced. In addition, the colors can be “corrected” such that their relative appearances better approximate a reproduction of the original or intended colors for the image. Further, the display can be implemented to provide a reproduction of the image that is perceived to be closer to the original or intended color gamut of that image.

An example of a suitable electromechanical systems (EMS) or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

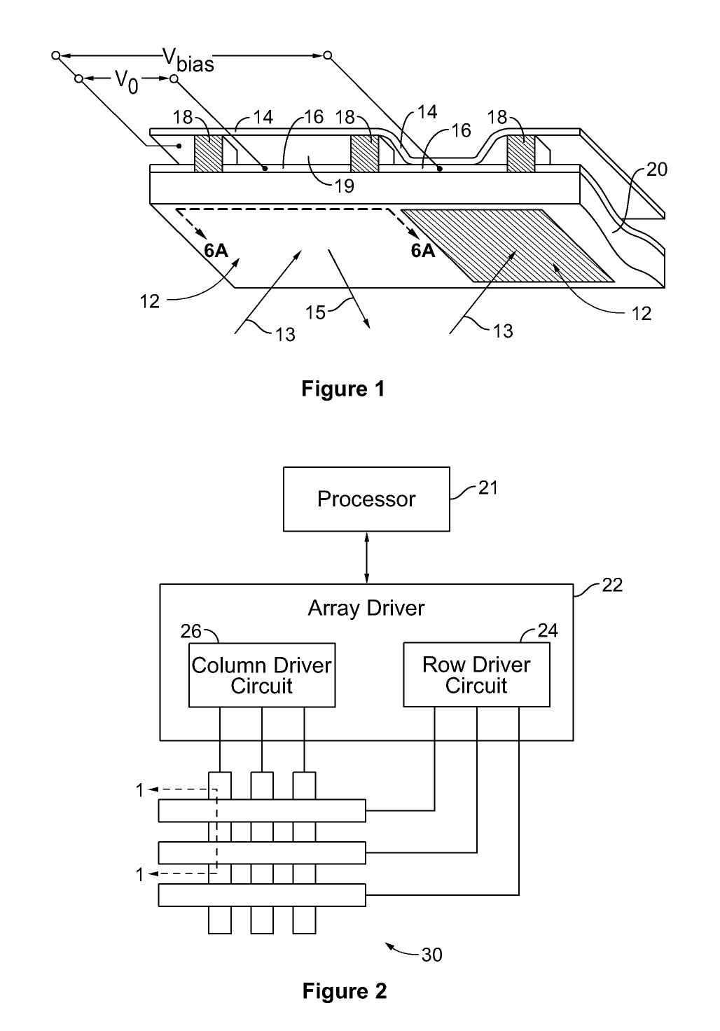

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

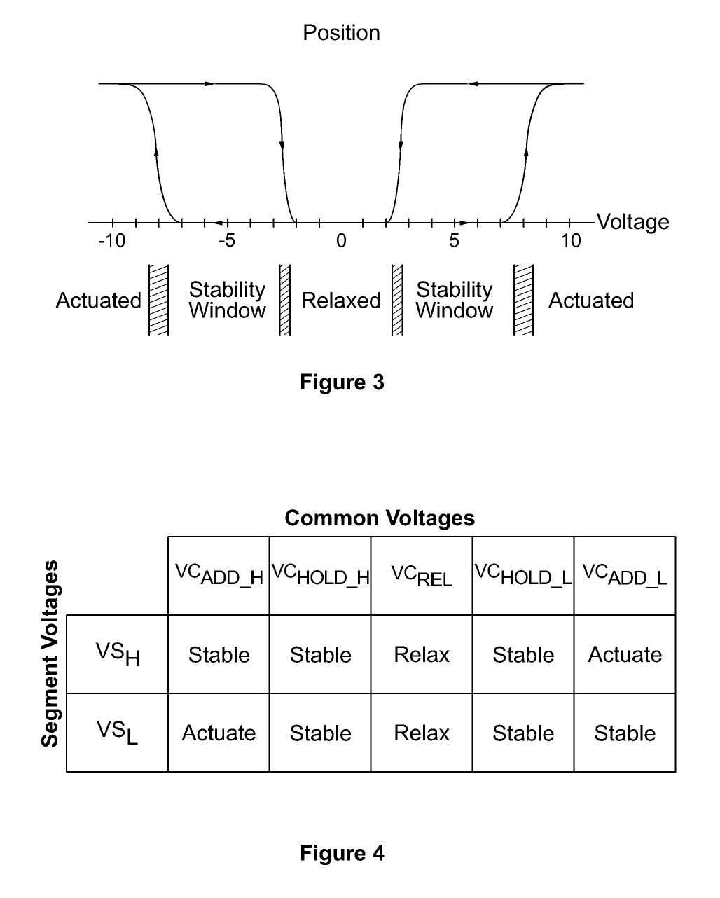

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

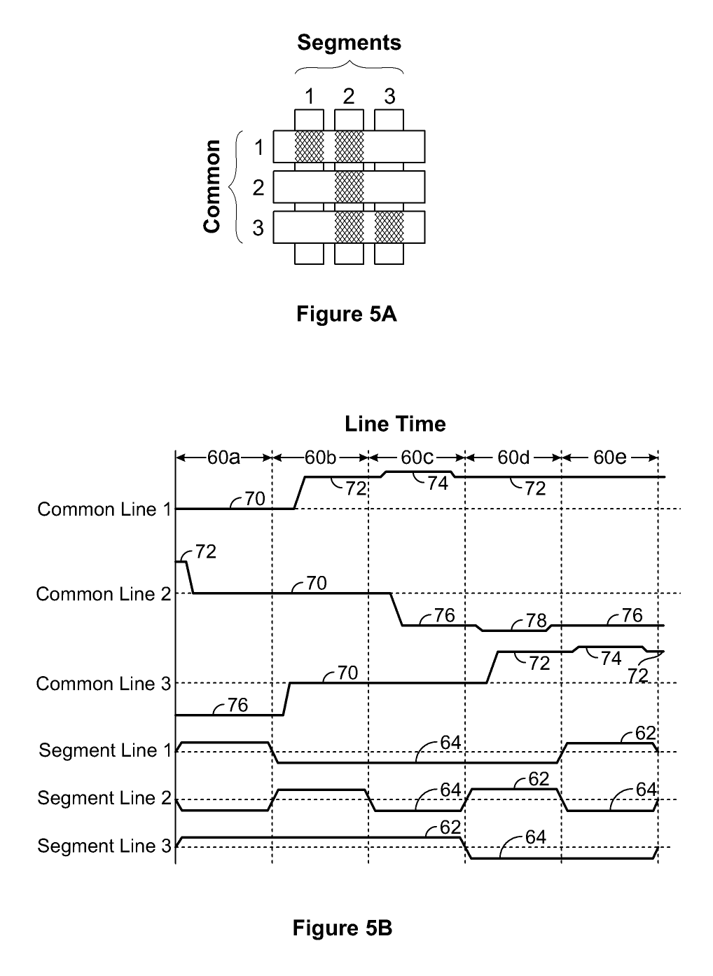

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1, 2) and (1, 3) along common line 1 remain in a relaxed, or unactuated, state for the duration of the first line time 60a, the modulators (2, 1), (2, 2) and (2, 3) along common line 2 will move to a relaxed state, and the modulators (3, 1), (3, 2) and (3, 3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}-relax and VC_{HOLD}_{_{—}}_{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3, 1), (3, 2) and (3, 3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1, 1) and (1, 2) is greater than the high end of the positive stability window (i.e., the voltage differential exceeded a predefined threshold) of the modulators, and the modulators (1, 1) and (1, 2) are actuated. Conversely, because a high segment voltage 62 is applied along segment line 3, the pixel voltage across modulator (1, 3) is less than that of modulators (1, 1) and (1, 2), and remains within the positive stability window of the modulator; modulator (1, 3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2, 2) is below the lower end of the negative stability window of the modulator, causing the modulator (2, 2) to actuate. Conversely, because a low segment voltage 64 is applied along segment lines 1 and 3, the modulators (2, 1) and (2, 3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3, 2) and (3, 3) actuate, while the high segment voltage 62 applied along segment line 1 causes modulator (3, 1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

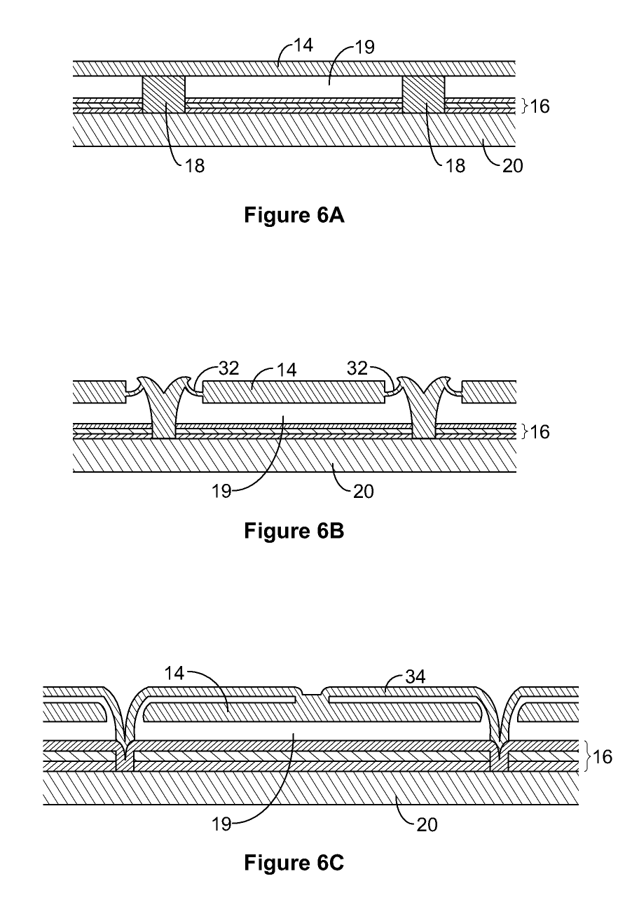

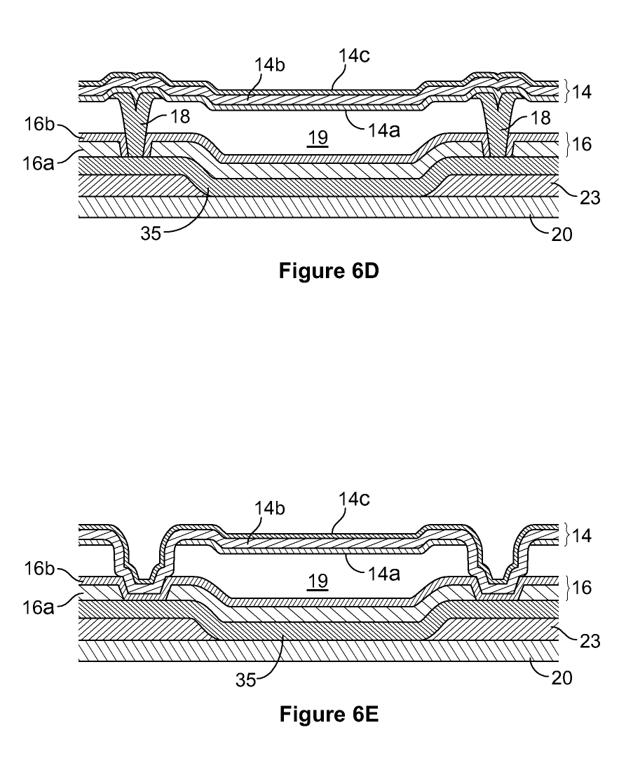

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a spacer layer (e.g., SiO₂), and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

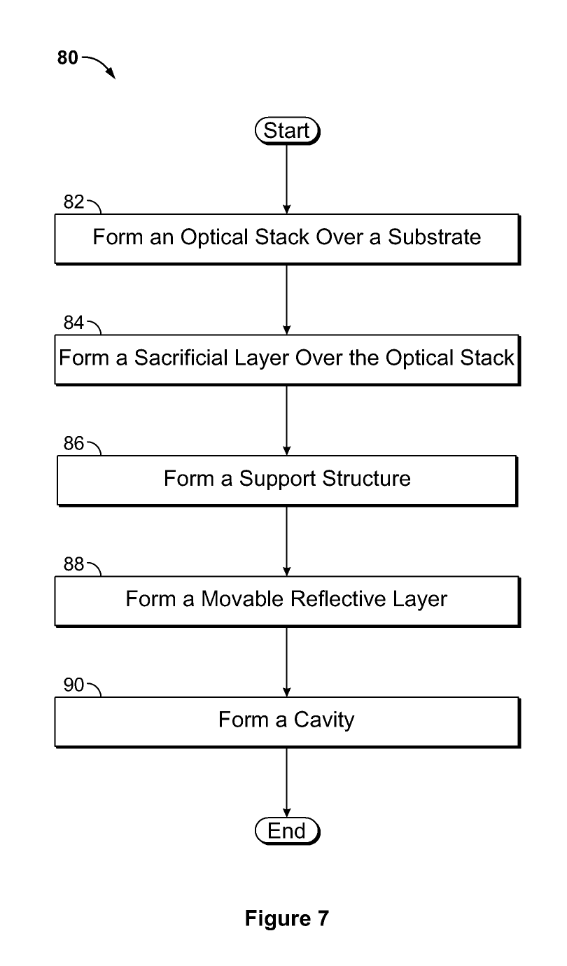

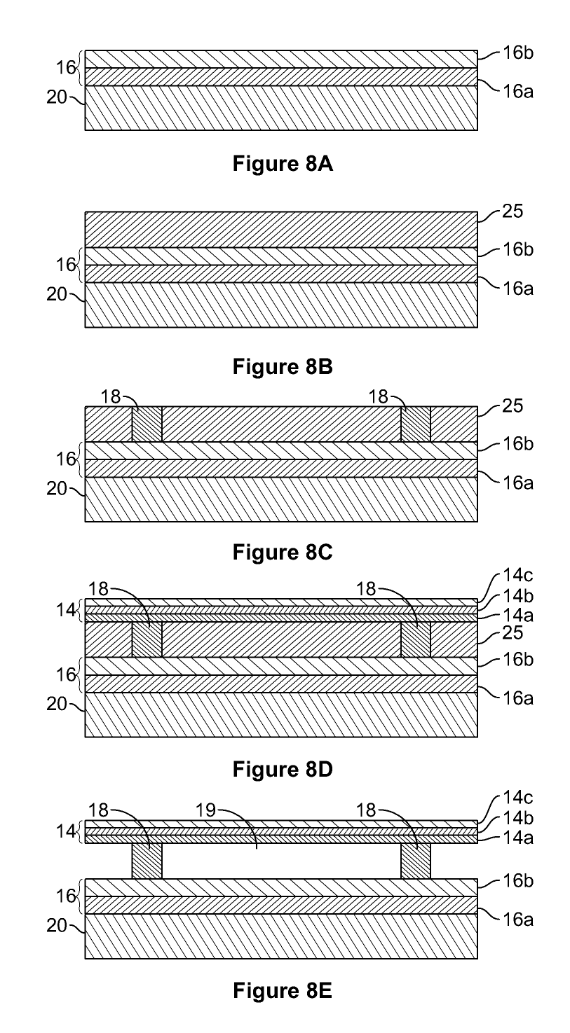

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

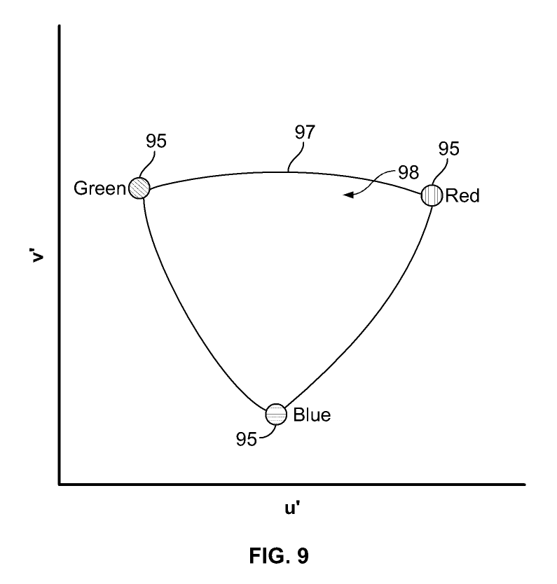

FIG. 9 is an example chromaticity diagram that illustrates the colors that can be produced by a display device that includes display elements that produce red, green, and blue colors. Display elements that produce red, green, and blue colors are sometimes referred to herein as red, green, and blue display elements. The chromaticity coordinates of a particular color can be defined by the horizontal and vertical axes of the chromaticity diagram. As an example, the end points 95 of the trace 97 can define the color of light produced by red, green, and blue display elements. The region 98 enclosed within the trace 97 can correspond to the range of colors that can be generated by mixing the light produced at end points 95. This range of colors can be referred to as the color gamut of the display device. In operation, each of the red, green and blue display elements in a pixel can be controlled to produce different mixtures of the red, green, and blue light that combine to form each color within the color gamut. In some other implementations, the color gamut of the display may be defined by different colors other than red, green, and blue, such as cyan, yellow, and magenta. In some other implementations, two or more complementary colors (that when combined produce a color that appears substantially neutral, e.g., gray, white or black) may be used. In some such implementations, the colors may be produced by display elements configured to reflect non-traditional colors that are generally not chosen for their ease to create a wide gamut of other colors (e.g., purplish-blue light (light at a wavelength in the region close to around 470-490 nm) and greenish-yellow light (light at a wavelength in the region close to around 570-600 nm)). Associated with each light source also can be a color gamut, which is the subset of colors found within the light produced by the light source.

Color temperature of a light source can generally be explained as the temperature of light emitted by a black body radiator. A black body radiator can be referred to an idealized object that absorbs all light incident upon the object and which can re-emit the light with a spectrum dependent on the temperature of the black body radiator. Lower color temperatures, e.g., less than 5,500 K, can be considered warm and can appear more yellow. Higher color temperatures, e.g., greater than 7,500 K, can be considered cool and can appear more blue. The color temperature of a display may be generally referred to as the color temperature of light emitted by, produced, or reflected from the display.

The white point of a light source can be considered as the hue that is generally neutral (e.g., gray or achromatic). The International Commission on Illumination (CIE) promulgates standardized white points of light sources. For example, light source designations of “D” refer to daylight. In particular, standard white points D₅₅, D₆₅, and D₇₅, which correlate with color temperatures of 5,500 K, 6,500 K, and 7,500 K respectively, are standard daylight white points. The white point of a light source with a lower color temperature, e.g., 5,500 K, can be perceived as having a yellowish white, while a light source with a higher color temperature, e.g., 7,500 K, can be perceived as having a bluish white.

Thus, human perception of the color of an object being displayed on a display device may be affected by the color temperature of the ambient light surrounding the display device. The color temperature of the ambient light can be corrected, modified or adjusted for emissive or projective display devices by providing supplemental lighting to the display device's light source. For example, by providing additional lighting, the color of the image can move away from the ambient light's color gamut, i.e., a first color gamut (e.g., an undesired color gamut) to create a second color gamut (e.g., a more desired color gamut) that provides for a closer reproduction of the colors within the image to the viewer.

For certain reflective display devices, e.g., display devices including interferometric modulators, which can use ambient light as a light source and may be without an auxiliary light source, the color gamut of the image generally remains within the color gamut of the ambient light. Thus, various implementations described herein provide a display device configured to correct, modify or adjust for the color temperature of the ambient light source without the use of an auxiliary light source, e.g., the output color remains within the color gamut of the ambient light.

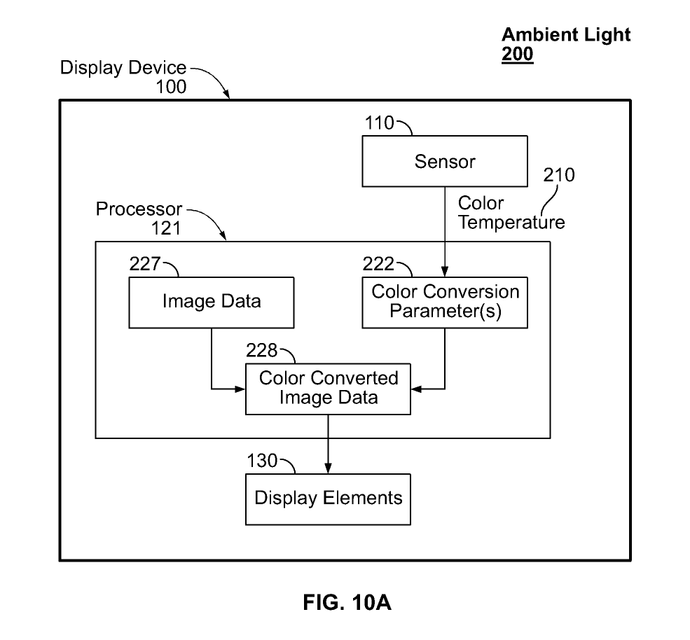

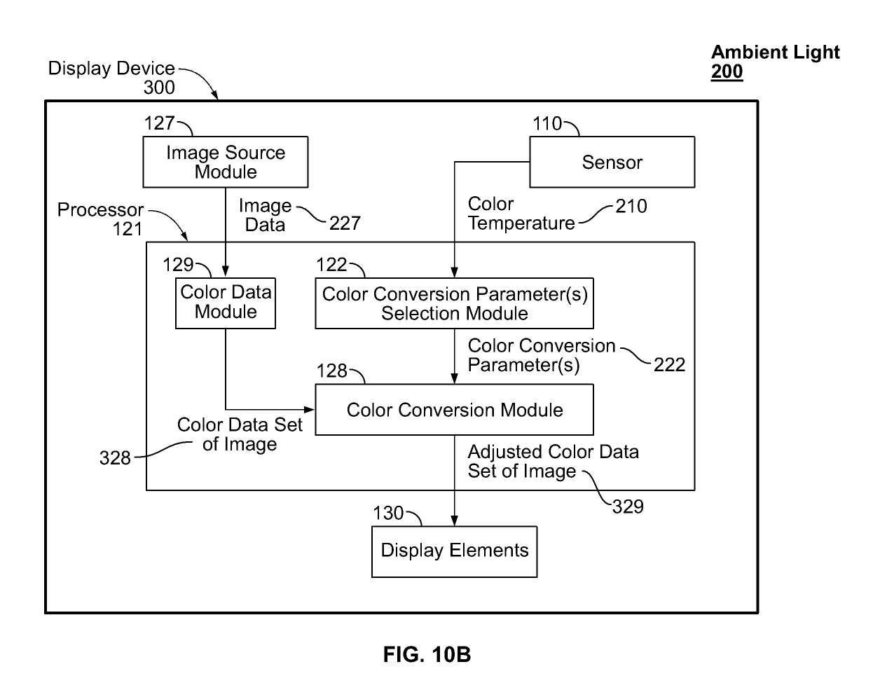

FIGS. 10A and 10B illustrate examples of display devices for displaying an image. In FIG. 10A, the display device 100 can include a set of display elements 130. Each display element can include at least one interferometric modulator having an interferometric cavity. An interferometric modulator can be configured to reflect ambient light 200. As shown in FIG. 10A, the display device 100 also can include a sensor 110 configured to determine, e.g., measure, calculate, or estimate, a color temperature of the ambient light 200. The display device 100 further can include a processor 121 configured to receive image data 227 to be displayed as an image by the set of display elements 130. The processor 121 also can be configured to determine at least one color conversion parameter 222 based at least in part on the color temperature 210. The processor 121 further can perform color conversion of the image data 227 based at least in part on the at least one color conversion parameter 222. The color conversion parameter 222 can be adapted to provide colors within a color gamut of the ambient light 200. The processor 121 can adjust at least one of the set of display elements 130 based at least in part on the color converted image data 228 to provide a color within the color gamut of the ambient light 200.

As discussed above, each of the display elements 130 can include at least one interferometric modulator. In some implementations, an interferometric modulator operating in a bi-stable mode (e.g., an interferometric modulator having a fixed cavity height) can be used. In some other implementations, an interferometric modulator operating in an analog mode (e.g., an interferometric modulator having a variable cavity height) can be used. Whether bi-stable or analog, each interferometric modulator can have an interferometric cavity and can be configured to reflect ambient light 200. As discussed herein, the spacing of the interferometric cavity can affect the reflectance of the interferometric modulator which, in turn, can generate different colors.

In various implementations, the ambient light 200 which is reflected by the interferometric modulator can include natural light sources, e.g., sunlight. The ambient light 200 also can include artificial light sources, e.g., fluorescent or incandescent light sources. Color temperatures of the ambient light 200 can vary depending on numerous factors. For example, the color temperature of sunlight can vary depending on the time of day. Further, color temperatures of the ambient light 200 from different types of artificial light sources (e.g., fluorescent or incandescent light bulbs) may vary. In another example, color temperatures of the ambient light 200 from artificial light sources of the same type, but from different manufacturers, may be different. Associated with each source of the ambient light 200 also can be a color gamut, which is the subset of colors found within the light produced by the light source.

The sensor 110, in some implementations, can be configured to determine, e.g., measure, calculate, or estimate, a color temperature of the ambient light 200. In some implementations, the sensor 110 can include a sensor such as those included in cameras. In some implementations, the sensor 110 can include a set of color sensors (e.g., photodiodes and/or associated color filters). For example, the color sensors may include red, green, and blue color sensors that output a signal proportional to the amount of red, green, and blue light, respectively. The output from the color sensors can be combined to determine a color temperature. In some other implementations, the sensor 110 can include a camera, and color temperature can be determined by taking a photograph and post-processing the photograph to determine the color temperature. In some implementations, the color temperature determined by the sensor 110 may correspond to a correlated color temperature (CCT), which may be the color temperature of a black body radiator which to human color perception most closely matches the determined light. The display device 100 also may use other information to estimate or determine potential color temperatures, instead of measuring the actual color temperatures. Some examples of such information include date, time, location of the display device 100, temperature, etc. For instance if the display device 100 is located outdoor during the day, the ambient light 200 is likely to include mostly sunlight, and hence, the display device 100 can determine or estimate the color temperature of the ambient light 200 to be the typical color temperature associated with sunlight.

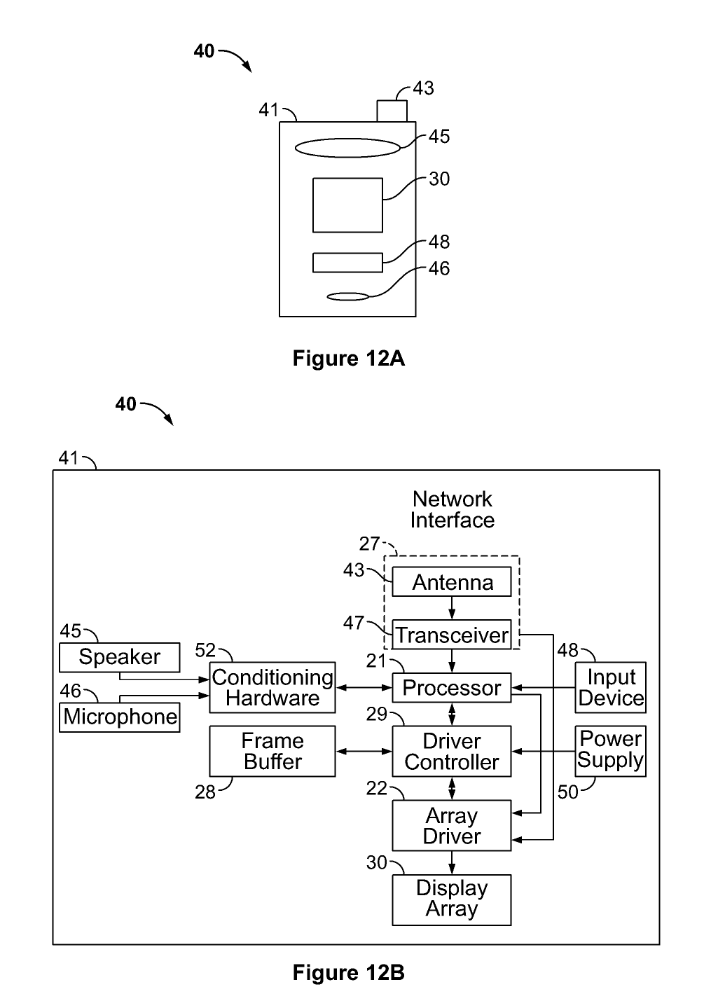

In some implementations, the processor 121 can be the processor 21 of FIG. 2 or FIG. 12B. The processor 121 can include a microcontroller, a central processing unit (CPU), or logic unit to control operation of the display device 100. The processor 121 can be configured to receive image data 227 to be displayed as an image by the set of display elements 130. For example, the processor 121 can receive image data 227, such as compressed image data from a network interface or an image source module. The processor 121 can process the image data 227 into raw image data or into a format that is readily processed into raw image data. The image data 227 can include information that identifies the image characteristics, e.g., color, saturation, and gray-scale level, at each location within an image.

The image data 227 relating to color can include the color chromaticity coordinates, e.g., three-dimensional coordinates in an RGB color model that can utilize red, green, and blue light to generate various colors. In some cases, a standard RGB color model (e.g., sRGB) can be used. As another example, the color chromaticity coordinates can be the (L, M, S) coordinates in a von Kries color model that can utilize Long, Medium, and Short wavelength values. As another example, the color chromaticity coordinates can utilize tri-stimulus values such as CIE (X, Y, Z) values or normalized values (x, y, z) determined from the (X, Y, Z) values. Other color space models can be used in other implementations (e.g., CIE L*a*b).

The processor 121 can be configured to determine whether to adjust the color of the image data 227 based at least in part on the determined color temperature 210. If the processor 121 determines to adjust the color of the image data 227, the processor 121 can be configured to determine at least one color conversion parameter 222 based at least in part on the determined color temperature 210. In some implementations, the processor 121 can determine a color conversion parameter 222 based on metadata, e.g., an input image color profile in a known color space in the image or media being displayed. For example, if the input data contains color chromaticity coordinates in an sRGB color model, the color conversion parameter 222 may be a determined white point of the ambient light 200 in an sRGB color model. The color conversion parameter 222 in other implementations can be a determined white point of the ambient light 200 in an RGB color model. In some other implementations, the color conversion parameter 222 can be a determined white point of the ambient light 200 in an LMS or von Kries color model. Measured or estimated parameters of the display, and/or parameters stored in an output color profile or specified by a known color space, such as sRGB, might also be used as parameters and/or inputs in determining the color conversion parameter 222.

The processor 121 can perform color conversion of the image data 227 based at least in part on the at least one color conversion parameter 222, and the color conversion can be adapted to provide colors within a color gamut of the ambient light 200. For example, using a determined white point in an RGB color model, the processor 121 can perform color conversion of the image data 227 by scaling values of the RGB color values so that white objects in an image can appear as substantially white. The input color, represented as values of red, green, and blue can then be converted to the scaled or adjusted chromaticity values. As another example, using a determined white point in an LMS color model, the color values of the image data 227 can be converted into Long, Medium, and Short wavelength cone types, scaled based at least in part on the determined white point, and then converted back into color values as the adjusted chromaticity values.

Colorimetric reproduction can be used to provide a reproduction of the image that is perceived to be closer to the original color gamut of the image. In some implementations, colorimetric reproduction can include adjusting color values to provide a color within the color gamut of the ambient light 200. For example, after scaling the color values, one or more adjusted color values that might be outside the color gamut of the ambient light 200 further can be adjusted to remain in the color gamut of the ambient light 200. Some implementations can limit or clamp a color value coordinate that might be above a maximum value, or below a minimum value, corresponding to a color range of the color gamut of the ambient light 200 so as to keep the color value coordinate within the color range of the color gamut of the ambient light 200. For example, if the color value coordinate might exceed the maximum value (or might be below the minimum value) of the color range, the color value coordinate can be limited to the maximum value (or minimum value).

Colorimetric reproduction, including adjustment to remain in the color gamut of the ambient light, can be absolute or relative in various implementations. For example, absolute colorimetric reproduction can involve color conversion of the image data 227 as discussed above by scaling the color values for light source correction. Relative colorimetric reproduction can involve scaling the color values for light source correction and also scaling for the output media correction (e.g., scaling for the output media white point). For example, in some proofing implementations, color conversion of the image data 227 as viewed on the display device 100 can also include scaling to adjust for how the image will appear on a tangible output medium (e.g., as printed on a piece of paper). In some such implementations, the processor 121 can perform color conversion by scaling the image data 227 based at least in part on the color temperature of the ambient light 200. The processor 121 also can perform color conversion by scaling the image data 227 based on a color parameter, e.g., white point, of the output medium. In some implementations, colorimetric reproduction can also involve other adjustment methods to the color values outside the color gamut of the ambient light 200, e.g., further scaling of color values. In some of these implementations, one or more color values within the color gamut of the ambient light 200 also can be further adjusted to maintain the perception of the image to be closer to the original color gamut of the image. For example, when one or more adjusted color values might be outside the color gamut of the ambient light 200, color values outside and/or inside the color gamut of the ambient light 200 can be adjusted, e.g., scaled, such that the color values outside the color gamut of the ambient light 200 are adjusted to be within the color gamut of the ambient light 200 to substantially maintain the perception. For example, in some implementations, some or all of the color values can be scaled such that color values that might be outside the gamut of the ambient light 200 are moved inside the gamut. In some such implementations, the color values can be linearly scaled, e.g., in XYZ or LMS.

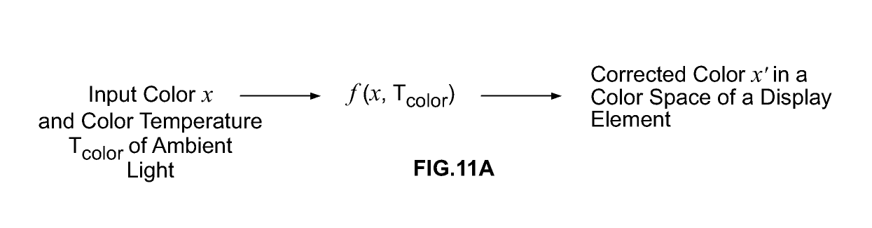

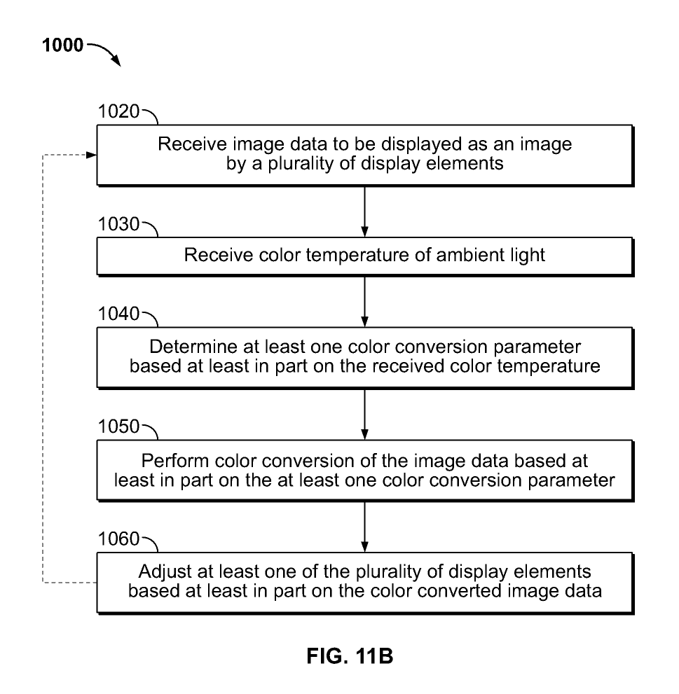

In some implementations, the processor 121 can be configured to perform the color conversion of the image data 227 based at least on one or more algorithms to scale the values, for example, as described herein (see, e.g., FIG. 11A). For example, various implementations may use color balancing or chromatic adaptation algorithms. In some other implementations, the processor 121 can be configured to perform the color conversion on the image data 227 based on one or more look-up tables (LUTs). For example, the processor 121 can use a one-dimensional LUT to operate on a single color value to perform an independent, non-linear, transformation on the single color. The other colors can be transformed into adjusted color values in a similar manner. As another example, the processor 121 can use one or more multi-dimensional LUTs, e.g., a three-dimensional RGB LUT, to operate on multiple color values simultaneously to output RGB color values for a non-linear conversion.

In some other implementations, a single color value can be transformed independently with a set of one-dimensional LUTs and then transformed with a multi-dimensional, e.g., three-dimensional, LUT to perform non-linear mixing. In implementations where the output color value has four primary colors, each entry in a multi-dimensional LUT can have four output color values. For some multi-dimensional transformations, relatively sparse LUTs can be used (e.g., 16×16×16 LUTs), and interpolation (e.g., bi-cubic interpolation) among the LUTs can be used to determine the output color values. In addition, in some implementations, after transformation with a multi-dimensional LUT, each color can once again be scaled with a set of one-dimensional LUTs to produce the output color value.

In some implementations, the one-dimensional LUT and/or multi-dimensional LUT can be generated for a set of calculated or estimated output color values and light sources. The LUTs can be generated by taking many measurements and can be based on profile specifications of, for example, the International Color Consortium (ICC).

In yet another implementation, the processor 121 can be configured to determine a standard color temperature, e.g., a CCT, that approximately matches the determined color temperature and then perform the color conversion of the image data 227 based at least in part on the standard color temperature. For example, the processor 121 can include LUTs for standard light sources. The processor 121 can estimate the closest (or a substantially close) standard light source to the determined color temperature (or to the determined white point) and perform color conversion using the LUTs for the closest (or substantially close) standard light sources. As an example, the processor 121 can use a known color conversion space, e.g., one or more color profiles promulgated by the International Color Consortium (ICC) (also known as ICC color profiles). In one such example, an approximate white point close to the estimated white point of the ambient light 200 can be used as the known color conversion space. For example, if the estimated white point is approximately D₆₅, a color profile containing parameters or LUTs for D₆₅ color space in RGB, sRGB, LMS, CIE XYZ, or CIE L*a*b can be used.

After performing color conversion of the image data 227, the processor 121 further can adjust at least one of the set of display elements 130 based at least in part on the color converted image data 228 to provide one or more colors within the color gamut of the ambient light 200. The processor 121 can adjust at least one of the set of display elements 130 by sending the color converted image data 228 to a driver controller (see, e.g., the driver controller 29 shown in FIG. 12B) as discussed below.

In some implementations, the sensor 110 can be configured to determine the color temperature 210 of the ambient light 200 when the processor 121 receives image data 227. The processor 121 can receive image data 227 many times, e.g., sometimes thousands or more times, per second.

As mentioned above, at least one of the display elements 130 may include an interferometric modulator having an interferometric cavity spacing which can be adjusted. For example, the processor 121 can communicate the color converted image data 228 to a driver controller to vary the height of an analog interferometric modulator. As another example, the processor 121 can communicate the color converted image data 228 to electronics of the display device 100 having a bi-stable interferometric modulator to adjust the cavity height by adjusting a non-zero bias voltage in the on-state. In yet another example, the processor 121 can communicate the color converted image data 228 to a driver controller to adjust the amount of time when the ambient light 200 is reflected by at least one analog or bi-stable interferometric modulator. As a further example, each interferometric modulator can include a reflective area. In some implementations, the size of the reflective area can be adjusted. In further implementations, a ratio of respective areas used to reflect different colors of light can be adjusted.

FIG. 10B illustrates another example implementation of a display device 300 for displaying an image. The display device 300 can include a set of display elements 130. Each of the display elements 130 can include at least one interferometric modulator configured to reflect ambient light 200. The display device 100 further can include a sensor 110 configured to determine, e.g., measure, a color temperature of the ambient light 200. The display device 100 further can include a processor 121. The processor 121 can be configured to receive image data 227 from an image source module 127. The image source module 127 can include a receiver, a transmitter, and/or a transceiver, such as those described further below with reference to FIG. 12B. The image data 227 can provide information on the image to be displayed by the set of display elements 130. The processor 121 can include a color conversion parameter selection module 122 that can be configured to determine at least one color conversion parameter 222 based at least in part on the color temperature 210 in order to correct or adjust for the color temperature of the ambient light 200 if desired. The processor 121 further can include a color conversion module 128 configured to receive the image data 227 as a color data set 328 of the image data from a color data module 129. The color conversion module 128 can be configured to provide an adjusted color data set 329 of the image based at least in part on the at least one color conversion parameter 222. The color conversion can be adapted to provide colors within a color gamut of the ambient light 200.

In some implementations, the processor 121 can be configured to perform the color conversion of the image data based at least on one or more algorithms. In some other implementations, the processor 121 can be configured to perform the color conversion on the image data based on one or more look-up tables (LUTs).

The processor 121 further can adjust at least one of the set of display elements 130 based at least in part on the adjusted color data set 329 to provide a color within the color gamut of the ambient light 200. The processor 121 can adjust at least one of the set of display elements 130 by sending the adjusted color data set 329 of the image to a driver controller (see, e.g., the driver controller 29 shown in FIG. 12B). In some implementations, the sensor 110 can be configured to determine the color temperature 210 of the ambient light 200 when the processor 121 receives image data 227 from the image source module 127. The processor 121 can be configured to provide an adjusted color data set 329 for each image to be displayed.

FIG. 11A illustrates an example algorithm to correct or adjust for color temperature of ambient light in a display device. The algorithm can be compatible with some implementations of the display device 100 described herein. For example, the algorithm can be implemented by the processor 121. The example algorithm can include entering an input color x into a function, ƒ, along with at least a color temperature, T_{coior}, of ambient light 200 to generate a corrected color x′ in a color space of a display element, such as one of the display elements 130 illustrated in FIGS. 10A and 10B.

As described herein, the function, ƒ can include scaling the color values of the input image data 227, e.g., RGB or sRBG space. In other implementations, the function, ƒ can include color conversion of the input image data 227, e.g., RGB or sRGB, into a particular color space model, e.g., a more perceptually uniform color space such as XYZ or LMS, scaling based at least in part on the determined white point, and then color conversion into the output color space, e.g., RGB or sRGB, to produce the color converted image data 228. In some implementations, the transformation of the color values into a particular color space can include gamma correction, e.g., linear approximation for a range and then application of a power law, and/or matrix multiplication. In some implementations, the transformed color values can be adjusted based at least in part on the determined white point, e.g, scaled, and then transformed into output color values to produce the color converted image data 228. In these implementations, the transformation into the output color values can include inverse matrix multiplication and/or gamma correction.

FIG. 11B illustrates an example method 1000 to correct or adjust for color temperature of ambient light in a display device. The method 1000 can include receiving image data 227 to be displayed as an image by a set of display elements 130 as shown in block 1020, receiving color temperature of ambient light 200, e.g., receiving a determined color temperature by a sensor 110, as shown in block 1030, and determining at least one color conversion parameter 222 based at least in part on the received color temperature 210 as shown in block 1040. In block 1050, the method 1000 further can include performing color conversion of the image data 227 based at least in part on the at least one color conversion parameter 222. The color conversion can be adapted to provide colors within a color gamut of the ambient light 200.

As shown in block 1060, the method 1000 further can include adjusting at least one of the set of display elements 130 based at least in part on the color converted image data 228. Adjusting at least one of the set of display elements 130 can include adjusting an interferometric cavity spacing of at least one interferometric modulator. Adjusting at least one of the set of display elements 130 also can include adjusting an amount of time when the ambient light 200 is reflected by at least one interferometric modulator. Furthermore, adjusting at least one of the set of display elements 130 also can include adjusting an area used to reflect light by at least one interferometric modulator.

In another example method to correct or adjust for color temperature of ambient light in a display device, the method 1000 optionally can include repeating blocks, e.g., 1020, 1030, 1040, 1050, and 1060, for images to be displayed. In some implementations of the method 1000, performing color conversion 1050 of the image data 227 can be based at least in part on one or more LUTs. In some other implementations, performing color conversion 1050 of the image data 227 can be based at least in part on one or more algorithms (see, e.g., FIG. 11A).

FIGS. 12A and 12B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players. The display device 100 (and components thereof) described with reference to FIGS. 10A and 10B can be generally similar to the display device 40.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 12B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. In certain implementations, the processor 21 can include the processor 121 or can function as the processor 121 described herein. Methods described herein, e.g., method 1000, can be implemented via execution of instructions by the processor 21. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design. Certain implementations of the display device 40 also can include a sensor 110 as described herein.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the lookup table, functions or formulas used to produce or use the lookup table may be stored on or transmitted over as one or more data structures or instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display device comprising:
a plurality of display elements capable of reflecting ambient light;
a sensor configured to determine a color temperature of the ambient light; and
a processor configured to:
receive image data to be displayed as an image by the plurality of display elements;
determine at least one color conversion parameter based at least in part on the color temperature;
perform color conversion of the image data based at least in part on the at least one color conversion parameter, the color conversion adapted to provide colors within a color gamut of the ambient light; and
adjust at least one of the plurality of display elements based at least in part on the color converted image data so as to provide a color within the color gamut of the ambient light.

2. The display device of claim 1, wherein the color conversion is configured to adjust one or more color values to remain in the color gamut of the ambient light.

3. The display device of claim 1, wherein the sensor is configured to determine the color temperature of the ambient light when the processor receives the image data.

4. The display device of claim 1, wherein the at least one color conversion parameter includes a white point of the ambient light.

5. The display device of claim 1, wherein the processor is configured to perform the color conversion of the image data based at least in part on one or more look-up tables.

6. The display device of claim 1, wherein the processor is configured to perform the color conversion of the image data based at least in part on one or more algorithms.

7. The display device of claim 1, wherein the processor is configured to:
determine a standard color temperature that approximately matches the determined color temperature; and
perform the color conversion of the image data based at least in part on the standard color temperature.

8. The display device of claim 1, wherein at least one display element includes an interferometric modulator.

9. The display device of claim 8, wherein the at least one of the plurality of display elements is adjusted by adjusting an interferometric cavity spacing of at least one interferometric modulator.

10. The display device of claim 8, wherein the at least one of the plurality of display elements is adjusted by adjusting an amount of time when the ambient light is reflected by at least one interferometric modulator.

11. The display device of claim 8, wherein at least one of the plurality of display elements is adjusted by adjusting a reflective area used to reflect the ambient light by at least one interferometric modulator.

12. The display device of claim 1, further comprising:
a memory device that is configured to communicate with the processor.

13. The display device of claim 12, further comprising:
a driver circuit configured to send at least one signal to at least one of the plurality of display elements.

14. The display device of claim 13, wherein the processor is configured to send at least a portion of the color converted image data to the driver circuit.

15. The display device of claim 12, further comprising:
an image source module configured to send the image data to the processor.

16. The display device of claim 15, wherein the image source module includes at least one of a receiver, transceiver, and transmitter.

17. The display device of claim 12, further comprising:
an input device configured to receive input data and to communicate the input data to the processor.

18. A display device comprising:
a plurality of display elements capable of reflecting ambient light;
means for determining a color temperature of the ambient light; and
means for adjusting at least one of the plurality of display elements based at least in part on the color temperature determined to provide colors within a color gamut of the ambient light.

19. The display device of claim 18, further comprising:
means for receiving image data to be displayed as an image by the plurality of display elements,
means for determining at least one color conversion parameter based at least in part on the color temperature, and
means for performing color conversion of the image data based at least in part on the at least one color conversion parameter, the color conversion adapted to provide colors within a color gamut of the ambient light.

20. The display device of claim 19, wherein the color conversion is configured to adjust one or more color values to remain in the color gamut of the ambient light.

21. The display device of claim 18, wherein the means for determining a color temperature of the ambient light includes a sensor.

22. The display device of claim 19, wherein the means for determining a color temperature of the ambient light is configured to determine the color temperature of the ambient light when the image data is received.

23. The display device of claim 18, wherein the means for adjusting at least one of the plurality of display elements includes a processor.

24. The display device of claim 19, wherein the means for determining at least one color conversion parameter includes a color conversion parameter selection module and the means for performing color conversion of the image data includes a color conversion module.

25. The display device of claim 19, wherein the at least one color conversion parameter is the white point of the ambient light.

26. The display device of claim 19, wherein the means for performing color conversion of the image data is configured to perform the color conversion of the image data based at least in part on one or more look-up tables.

27. The display device of claim 19, wherein the means for performing color conversion of the image data is configured to perform the color conversion of the image data based at least in part on one or more algorithms.

28. The display device of claim 19, wherein:
the means for determining at least one color conversion parameter is configured to determine a standard color temperature that approximately matches the color temperature, and
the means for performing color conversion of the image data is configured to perform the color conversion of the image data based at least in part on the standard color temperature.

29. The display device of claim 18, wherein at least one display element includes an interferometric modulator.

30. The display device of claim 29, wherein the at least one of the plurality of display elements is adjusted by adjusting an interferometric cavity spacing of at least one interferometric modulator.

31. The display device of claim 29, wherein the at least one of the plurality of display elements is adjusted by adjusting an amount of time when the ambient light is reflected by at least one interferometric modulator.

32. The display device of claim 29, wherein the at least one of the plurality of display elements is adjusted by adjusting a reflective area used to reflect the ambient light by at least one interferometric modulator.

33. A method for color correction in a display device, comprising:
(a) receiving image data to be displayed as an image by the display device, the display device including a plurality of display elements capable of reflecting ambient light;
(b) receiving a color temperature of the ambient light;
(c) determining at least one color conversion parameter based at least in part on the received color temperature;
(d) performing color conversion of the image data based at least in part on the at least one color conversion parameter, the color conversion adapted to provide colors within a color gamut of the ambient light; and
(e) adjusting at least one of the plurality of display elements based at least in part on the color converted image data.

34. The method of claim 33, wherein the color conversion is configured to adjust one or more color values to remain in the color gamut of the ambient light.

35. The method of claim 33, wherein performing color conversion of the image data is based at least in part on one or more look-up tables or algorithms.

36. The method of claim 33, wherein at least one display element includes an interferometric modulator.

37. The method of claim 36, wherein adjusting at least one of the plurality of display elements includes one or more of: adjusting an interferometric cavity spacing of at least one interferometric modulator, adjusting an amount of time when the ambient light is reflected by at least one interferometric modulator, and adjusting an area used to reflect the ambient light by at least one interferometric modulator.

38. A non-transitory tangible computer storage medium having stored thereon instructions that, when executed by a computing system, causes the computing system to perform operations, the operations comprising:
receiving image data to be displayed as an image by a plurality of display elements capable of reflecting ambient light;
receiving a color temperature of the ambient light;
determining at least one color conversion parameter based at least in part on the received color temperature; and
performing color conversion of the image data based at least in part on the at least one color conversion parameter, the color conversion adapted to provide colors within a color gamut of the ambient light.

39. The non-transitory tangible computer storage medium of claim 38, wherein the color conversion is configured to adjust one or more color values to remain in the color gamut of the ambient light.

40. The non-transitory tangible computer storage medium of claim 38, wherein the operations further comprise:
adjusting at least one of the plurality of display elements based at least in part on the color converted image data.

41. The non-transitory tangible computer storage medium of claim 38, wherein performing color conversion of the image data is based at least in part on one or more look-up tables.

42. The non-transitory tangible computer storage medium of claim 38, wherein performing color conversion of the image data is based at least in part on one or more algorithms.

43. The non-transitory tangible computer storage medium of claim 38, wherein the operations further comprise:
determining a standard color temperature that approximately matches the received color temperature, wherein performing the color conversion of the image data is based at least in part on the standard color temperature.
